(19) United States
(12) Patent Application Publication
(10) Pub. No.: US 2010/0055292 A1
(43) Pub. Date: Mar. 4, 2010

(54) Black Pepper Substitute

(76) Inventor: Dennis Joseph Dougherty, St Augustine, FL (US)

Correspondence Address: Dennis J. Dougherty, 702 16th St, Anastasia Island, FL, 32080, US

(21) Appl. No.: 12/204,001

(22) Filed: Sep. 4, 2008

(51) Int. Cl. A23L 1/223

(52) U.S. Cl. 426/651; 426/650

(57) ABSTRACT

I propose to make a black pepper substitute. A product that will shake like ground black pepper and taste like black pepper without the peppercorn shell. Product ingredients will be free of the contaminants inherent to black pepper.

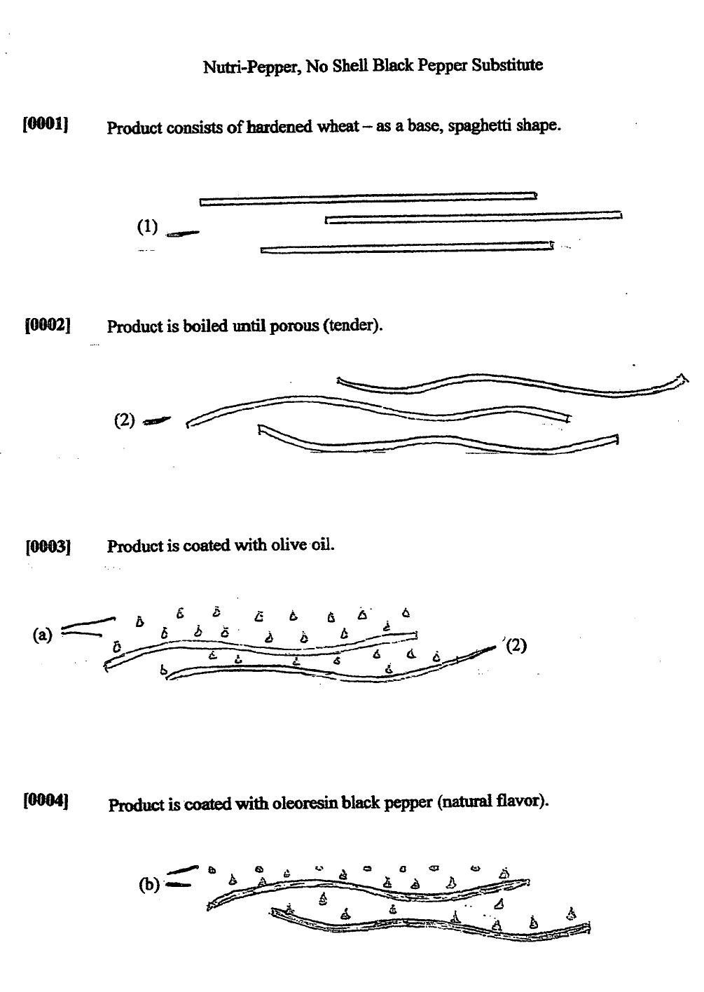

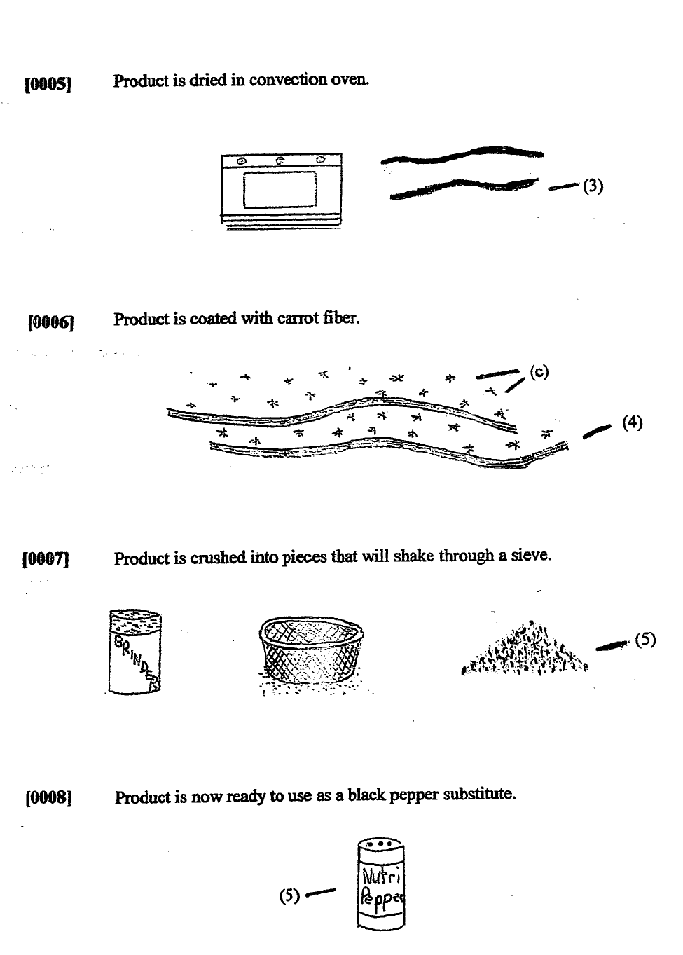

### IMITATION BLACK PEPPER/BLACK PEPPER SUBSTITUTE

Black pepper seasoning without the peppercorn shell made from wheat as a shell imitator, coated with olive oil and oleoresin of black pepper for flavor, dried, then coated with carrot fiber and crushed to a size that can shake on.

Product (1) consists of hardened wheat as a base. Spaghetti shape.

Product (1) is boiled in water until porous (tender) (becomes product (2)). It is then drained.

Product (2) is coated with olive oil (a) while being mixed in a bowl.

Product (2) is coated with oleoresin of black pepper (b) (natural flavor) while being mixed in a bowl.

Product (2) is dried in a oven on sheet pans and becomes product (3).

Product (3) is coated with carrot fiber (c) in a closed container allowing it to adhere and becomes product (4).

Product (4) is crushed to a size that will shake through a sieve and becomes product (5).

Product (5) is ready to be used as a black pepper substitute and packaged in a bottle ready to shake.

1. Product will have the flavor of black pepper without the shell of the peppercorn being present.

2. Product will shake out of a peppershaker like ground black pepper without the shell of the black peppercorn being present.

3. Using oleoresin of pepper nigrum (black pepper) to coat on the shell imitator, the product will have the same taste and smell of black pepper, but without the shell.
